(19) United States
(12) Patent Application Publication
(10) Pub. No.: US 2014/0111610 A1
(43) Pub. Date: Apr. 24, 2014

(54) METHOD AND APPARATUS FOR PLAYING THREE-DIMENSIONAL GRAPHIC CONTENT

(71) Applicants: Raejoo Ha, Seoul (KR); Hyojoon Im, Seoul (KR)

(72) Inventors: Raejoo Ha, Seoul (KR); Hyojoon Im, Seoul (KR)

(73) Assignee: LG ELECTRONICS INC., Seoul (KR)

(21) Appl. No.: 14/123,950

(22) PCT Filed: Aug. 18, 2011
(86) PCT No.: PCT/KR2011/006079

§ 371 Date: Dec. 4, 2013

(30) Foreign Application Priority Data
Jun. 10, 2011 (KR) 10-2011-0056458

(51) Int. Cl. H04N 13/00; H04N 13/02

(52) U.S. Cl. CPC H04N 13/0022; H04N 13/026
USPC 348/43

(57) ABSTRACT

The present invention relates to a method and an apparatus for playing three-dimensional graphic content, and more particularly, provides a method and an apparatus for playing three-dimensional graphic content comprising the following steps: reading two-dimensional graphic content comprising a two-dimensional graphic image, which includes at least one object; receiving an output command signal for the object; setting depth information, which indicates a stereoscopic degree of the object for which the output command signal is received; and generating the three-dimensional graphic content comprising a left eye graphic image and a right eye graphic image, by using the depth information of the object, which is set, wherein in the step of setting the depth information, a value of the depth information of the object is increased according to a reception order of the output command signal for the object.

### FIELD OF THE INVENTION

The present invention relates to a method and apparatus for playing three-dimensional graphic content and, more particularly, to a method and apparatus for converting two-dimensional graphic content to three-dimensional graphic content and playing the converted content by using an output order of objects.

### BACKGROUND ART

With the outstanding and remarkable growth in the recent technology, diverse types of devices that can play three-dimensional (3D) graphic content are being developed and commercialized. However, due to a limited selection of 3D graphic content, a problem in that users become incapable of properly using the apparatus for playing 3D graphic content frequently occurs.

In order to view a desired set of 3D graphic content, the user was required to wait until graphic content manufacturers convert the already-existing two-dimensional (2D) graphic content to 3D graphic content and then release the converted 3D graphic content.

Accordingly, in order to allow the users to view a wider range of 3D content, a method and apparatus, and so on, for generating 3D graphic content by using already-existing 2D graphic content are being required.

### DETAILED DESCRIPTION OF THE INVENTION

### Technical Objects

In order to resolve the above-described technical problem of the present invention, an object of the present invention is to provide a method and apparatus for playing three dimensional (3D) graphic content that can efficiently convert already-existing 2D graphic content to 3D graphic content.

### Technical Solutions

reading two-dimensional graphic content consisting of a two-dimensional graphic image, the two-dimensional graphic image including at least one object; receiving an output command signal of the object; setting up depth information representing a stereoscopic degree of an object having received the output command signal; and generating three-dimensional graphic content consisting of a left eye graphic image and a right eye graphic image using the set depth information of the object, wherein the step of setting up depth information increases depth information value of the object based upon a received order of the output command signal of the object.

Additionally, the present invention includes an exemplary embodiment setting up depth information by using position information of the object within the two-dimensional graphic image.

Additionally, the present invention includes an exemplary embodiment setting up depth information by using size information of the object within the two-dimensional graphic image.

Additionally, the present invention includes an exemplary embodiment, wherein the output command signal corresponds to an API (Application Programming Interface).

Additionally, the present invention includes an exemplary embodiment including the steps of grouping the objects into object groups; and setting up depth information for each of the object groups.

Additionally, the present invention includes an exemplary embodiment further including the steps of measuring a viewing direction of a user; and outputting the object at a stereoscopic degree being inclined toward the measured viewing direction of the user.

Additionally, the present invention includes an exemplary embodiment including the steps of measuring a position of the user, or measuring an inclination of an output device.

Additionally, the present invention includes an exemplary embodiment, wherein, in the step of generating three-dimensional graphic content, based upon depth information of the object, a difference in a distance between the object of the left eye graphic image and the object of the right eye graphic image is set up.

Moreover, provided herein is an apparatus for playing three-dimensional graphic content including an output unit configured to output three-dimensional graphic content, the three-dimensional graphic content consisting of a left eye graphic image and a right eye graphic image; a signal processing unit configured to decode the three-dimensional graphic content; and a controller configured to read two-dimensional graphic content consisting of a two-dimensional graphic image, the two-dimensional graphic image including at least one object, to receive an output command signal of the object, to set up depth information representing a stereoscopic degree of an object having received the output command signal, and to control the signal processing unit to generate the three-dimensional graphic content using the set depth information of the object, wherein the controller increases depth information value of the object based upon a received order of the output command signal of the object.

Additionally, the present invention includes an exemplary embodiment, wherein the controller sets up depth information of the object using position information of the object within the two-dimensional graphic image.

Additionally, the present invention includes an exemplary embodiment, wherein the controller sets up depth information of the object using size information of the object within the two-dimensional graphic image.

Additionally, the present invention includes an exemplary embodiment, wherein the output command signal corresponds to an API (Application Programming Interface).

Additionally, the present invention includes an exemplary embodiment, wherein the controller groups the objects into object groups, and sets up depth information for each of the object groups.

Additionally, the present invention includes an exemplary embodiment further comprising a sensor unit configured to measure a position of the user, or to measure an inclination of the output unit.

Additionally, the present invention includes an exemplary embodiment, wherein the controller controls the sensor unit to measure a viewing direction of a user, and outputs the object at a stereoscopic degree being inclined toward the measured viewing direction of the user.

Additionally, the present invention includes an exemplary embodiment, wherein, based upon depth information of the object, the controller sets up a difference in a distance between the object of the left eye graphic image and the object of the right eye graphic image, so as to generate the 3D graphic content.

It will be apparent that the present invention will not be limited only to the above-described exemplary embodiment of the present invention, and, as it is described in the appended claims of the present invention, it will also be apparent that variations and modification may be performed on the embodiments of the present invention by anyone skilled in the art and that such variations and modification will not depart from the scope and spirit of the present invention.

### Effects of the Invention

By being configured to have the above-described structure, the method and apparatus for playing 3D graphic content according to the present invention may convert 2D graphic content to 3D graphic content without performing any correction on the 2D graphic content. Moreover, 2D graphic content may be efficiently converted to 3D graphic content without any additional equipment or cost. And, since 2D graphic content that is already released in the market are being used, a wider range of 3D graphic content may be provided to the user.

### BRIEF DESCRIPTION OF THE DRAWINGS

FIG. 1 illustrates 2D graphic content and 3D graphic content according to an exemplary embodiment of the present invention.

FIG. 2 illustrates a drawing for describing depth information of 3D graphic content according to the exemplary embodiment of the present invention.

FIGS. 3 and 4 illustrate output methods of 2D graphic content and 3D graphic content according to the exemplary embodiment of the present invention.

FIG. 5 illustrates a flow chart showing a method of converting 2D graphic content to 3D graphic content according to the exemplary embodiment of the present invention.

FIG. 6 illustrates a conceptual view of an object group according to the exemplary embodiment of the present invention.

FIG. 7 illustrates a drawing for describing the output of 3D graphic content with respect to a viewing direction of the user according to the exemplary embodiment of the present invention.

FIG. 8 illustrates a flow chart showing a method of outputting 3D graphic content with respect to a viewing direction of the user according to the exemplary embodiment of the present invention.

FIG. 9 illustrates a block view showing an apparatus for playing 3D graphic content according to the exemplary embodiment of the present invention.

FIG. 10 illustrates a block view showing the structure of a signal processing unit shown in FIG. 9 in more detail.

### BEST MODE FOR CARRYING OUT THE PRESENT INVENTION

Hereinafter, the exemplary embodiments of the present invention will be described in detail, so that the exemplary embodiments of the present invention can be easily carried out by anyone having general knowledge in the technical field to which the present invention belongs with reference to the accompanying drawings. Hereinafter, in the description of the present invention, the same term and reference numerals will be used for the same element for simplicity.

Although the terms used in the present invention are selected from generally known and widely used terms, the terms used herein may also include terms selected by the applicant at his or her discretion. And, in this case, the meaning of such terms will be described in detail in relevant parts of the description herein. Therefore, it is required that the present invention is understood, not simply by the actual terms used but by the meaning of each term lying within.

Additionally, the suffixes “module” and “unit” respective to the elements that are used in the present description are merely used individually or in combination for the purpose of simplifying the description of the present invention. Therefore, the suffix itself will not be used to differentiate the significance or function or the corresponding term.

An apparatus for playing three dimensional (3D) graphic content (or 3D graphic content playing device) (100), which is described in the description of the present invention may include all types of devices that can output 3D images, such as a TV (Television), a Hand Phone, a Smart Phone, a Personal Computer, a Laptop Computer, a Digital Broadcasting Device, a Navigation (or navigator), a PMP (Portable Multimedia Player), a PDA (Personal Digital Assistants), and so on.

In the description of the present invention, a TV (Television) will be given as an example of the 3D graphic content playing device (100).

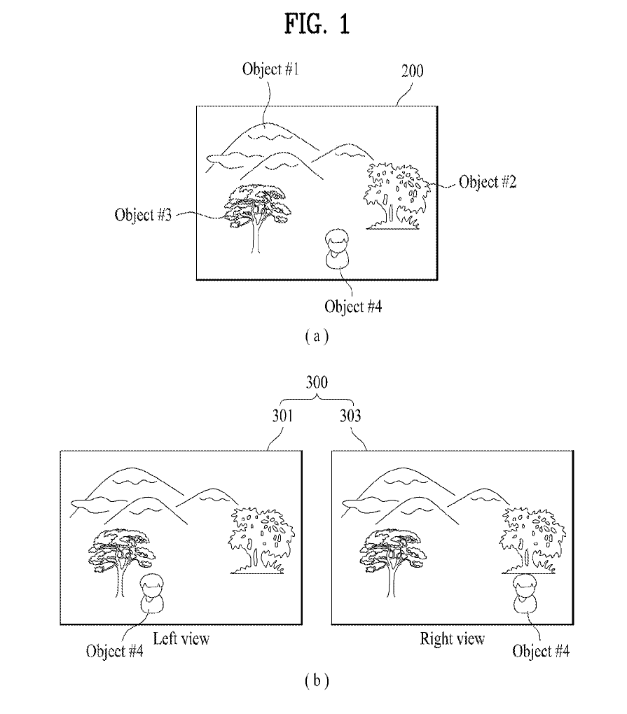

FIG. 1 illustrates 2D graphic content (200) and 3D graphic content (300) according to an exemplary embodiment of the present invention.

Fig. (a) illustrates 2D graphic content (200), and Fig. (b) illustrates 3D graphic content (300).

As shown in the drawing, the 2D graphic content (200) consists of one Graphic Images. And, each graphic image is configured of at least one Object. 4 objects are included in the graphic image of the 2D graphic content (200) shown in the drawing. The 3D graphic content playing device (100) according to the present invention may output the objects on a single screen and may play (or reproduce) 2D graphic content.

Additionally, the 3D graphic content (300) consists of a left eye graphic image (301) and a right eye graphic image (303). The left eye graphic image (301) includes objects that are seen through a left-eye view of the user, and the right eye graphic image (303) includes objects that are seen through a right-eye view of the user.

As a method for providing the user with the 3D graphic content (300), a binocular parallax acquiring a stereoscopic degree (or 3D effect) may be used by having the user view the same object from different directions respective to each of the left and right eyes.

Accordingly, a 2D image having a binocular parallax is separately outputted to each of the left eye and the right eye. Thereafter, a 3D image may be provided to the user through special glasses, such as polarized glasses, by using a method of alternately exposing a left-view image to the left eye and a right-view image to the right eye of the user.

Thus, the 3D graphic content (300) according to the present invention consists of the left eye graphic image (301) being exposed to the left eye of the user and the right eye graphic image (303) being exposed to the right eye of the user.

Additionally, the 3D graphic content playing device (100) according to the present invention reads the above-described 3D graphic content (300) and decodes the read 3D graphic content (300). The left eye graphic image (301) and the right eye graphic image (303) are sequentially read and then decoded as a single 3D stereoscopic image. The decoded 3D image data are, thus, outputted to the user through an output unit of the 3D graphic content playing device (100). Subsequently, the user wears special glasses (13), such as polarized glasses, thereby being capable of enjoying the 3D image.

For reference, although a stereoscopic method requiring the usage of special glasses has been given as an example in the description provided above, the present invention may also be applied to an Autostereoscopic method.

The 3D graphic content (300) is configured so that each object can be provided with a stereoscopic degree. More specifically, graphic images (301, 303) are configured so that objects can appear to be spaced apart from the output unit towards the directions of the user.

Referring to the drawing, object 4 (object #4) of the 3D graphic content (300) shown in the drawing is configured to have a stereoscopic degree. Due to a difference in the distance of object 4 (object #4) between the left eye graphic image (301) and the right eye graphic image (303), object 4 (object #4) is outputted to have a stereoscopic degree.

As the difference in the distance of object 4 (object #4) between the left eye graphic image (301) and the right eye graphic image (303) becomes larger, object 4 (object #4) is outputted to have a greater stereoscopic degree (or 3D effect), and as the difference in the distance becomes smaller, object 4 (object #4) is outputted to have a smaller stereoscopic degree.

In the description of the present invention, a level of the stereoscopic degree of the objects will be referred to as Depth Information.

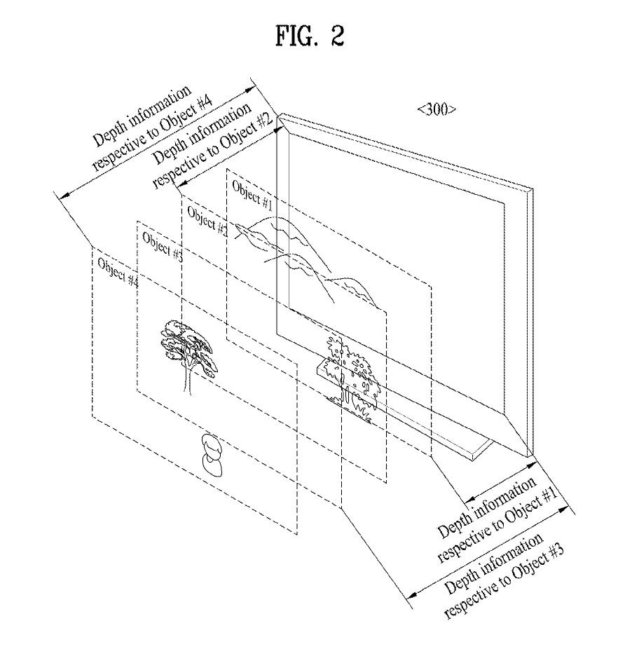

FIG. 2 illustrates a drawing for describing depth information of 3D graphic content according to the exemplary embodiment of the present invention.

The depth information corresponds to information indicating up to which stereoscopic degree the corresponding object is being outputted. More specifically, the depth information corresponds to information indicating how far away the corresponding object is being outputted from the output unit towards the user's direction.

The 3D graphic content (300) of the drawing includes 4 objects, and object 1 (object #1) is outputted with the lowest stereoscopic degree, and object 4 (object #4) is outputted with the greatest stereoscopic degree. More specifically, object 1 (object #1) is outputted at a position most approximate to the displayer, and object 4 (object #4) is outputted at a position furthermost away from the displayer.

Therefore, the depth information of object 1 (object #1) has the smallest value, and the depth information of object 4 (object #4) has the greatest value.

Additionally, as described above, the depth information of each object is decided by a difference in the distance between the corresponding object and the left eye graphic image (301) and the distance between the corresponding object and the right eye graphic image (303). Accordingly, the 3D graphic content playing device (100) of the present invention may adjust the difference in the distance between the corresponding object and the left eye graphic image (301) and the distance between the corresponding object and the right eye graphic image (303), thereby controlling (or adjusting) the stereoscopic degree of the corresponding object.

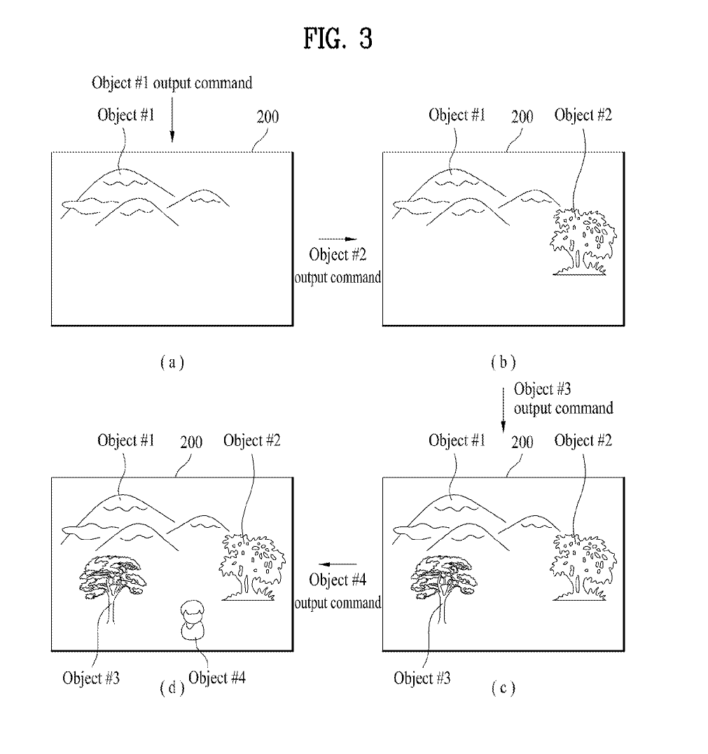

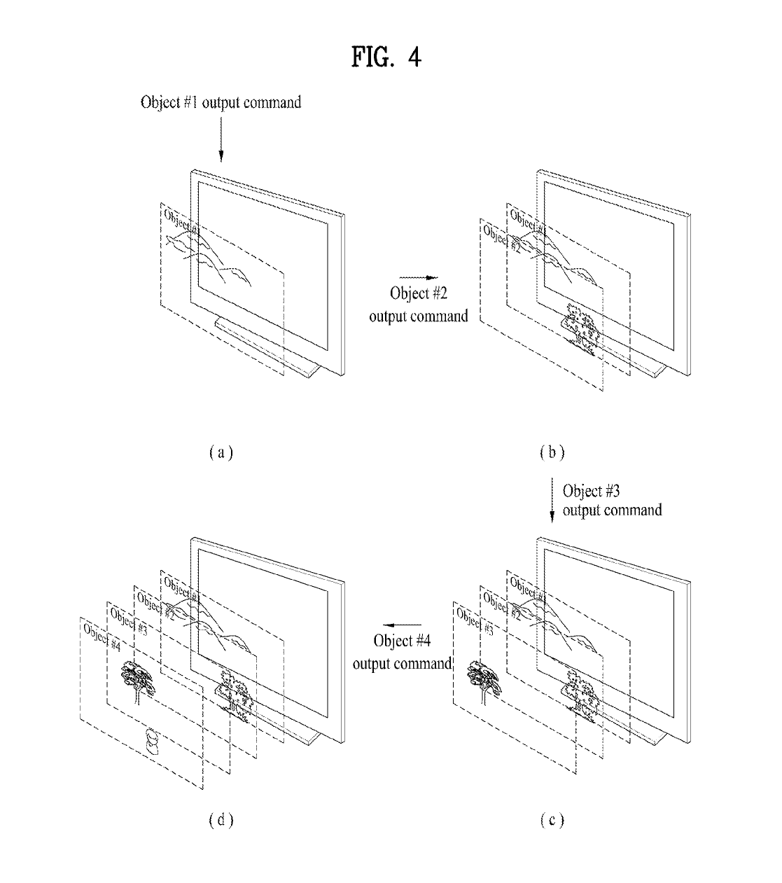

FIGS. 3 and 4 illustrate output methods of 2D graphic content (200) and 3D graphic content (300) according to the exemplary embodiment of the present invention.

FIG. 3 illustrates an output of 2D graphic content (200), and FIG. 4 illustrates an output of 3D graphic content (300).

As described above, each of the 2D graphic content (200) and the 3D graphic content (300) consists of one graphic image having multiple objects included therein. Each of the objects is outputted on the screen in accordance with the output command of the respective object.

An example of the output command according to the present invention may correspond to a control signal of an API (Application Programming Interface) or a 3D graphic content playing device (100).

The API (Application Programming Interface) refers to a group of commands included in an application program, which plays graphic content. Therefore, the 3D graphic content playing device (100) according to the present invention may call on an output API of the corresponding object in accordance with the decided object output order.

In the 2D graphic content (200) and the 3D graphic content (300) of the drawing, the object output order is decided so that the objects can be sequentially outputted starting from object 1 (Object #1) to object 4 (Object #4), and 3D graphic content playing device (100) calls on the corresponding object output command in accordance with the decided object output order.

When an output command of object 1 (Object #1) is called, object 1 (Object #1) is outputted on the screen, as shown in Fig. (a), and when an output command of object 2 (Object #2) is called, object 2 (Object #2) is outputted on the screen, as shown in Fig. (b). Similarly, when an output command of object 3 (Object #3) is called, object 3 (Object #3) is outputted on the screen, as shown in Fig. (c), and when an output command of object 4 (Object #2) is called, object 4 (Object #4) is outputted on the screen, as shown in Fig. (d), thereby outputting a 2D image or a 3D image.

The output order of each object is stored in a corresponding application program or in the 2D graphic content (200), and the 3D graphic content playing device (100) according to the present invention receives an output command signal of the called object in accordance with the output order, thereby outputting the corresponding object.

Hereinafter, a method of converting 2D graphic content (200) to 3D graphic content (300) and playing the converted graphic content, by using the above-described output order of the objects, will be described in detail.

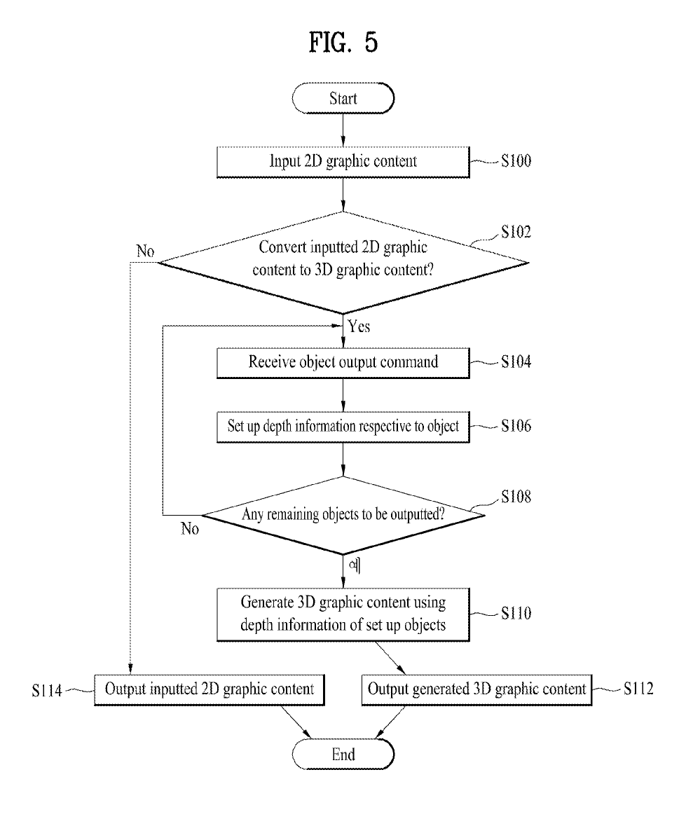

FIG. 5 illustrates a flow chart showing a method of converting 2D graphic content (200) to 3D graphic content (300) according to the exemplary embodiment of the present invention.

First of all, the 3D graphic content playing device (100) of the present invention receives 2D graphic content (200). (S100) As described above, the 2D graphic content (200) consists of graphic images including multiple objects.

Additionally, based upon the user's command, the 3D graphic content playing device (100) determines whether to play the 2D graphic content (200) as a 2D image or whether to convert the 2D graphic content (200) to a 3D graphic image. (S102)

In accordance with the user's command to play the 2D graphic content (200) as a 2D image, the 3D graphic content playing device (100) outputs the 2D graphic content (200) still as a 2D image without performing any conversion. (S 114)

In accordance with the user's command to play the 2D graphic content (200) as a 3D image, the 3D graphic content playing device (100) performs a process of converting the 2D graphic content (200) to 3D graphic content (300). Hereinafter, the process of converting the 2D graphic content (200) to 3D graphic content (300) will be described in detail.

The 3D graphic content playing device (100) receives output commands of the objects being included in the 2D graphic content (200). (S104) As described above, in accordance with the object output order, an output command (API) of the corresponding object is called. The 3D graphic content playing device (100) receives a called object output command signal.

The 3D graphic content playing device (100) sets up depth information of an object having its output command called upon. The 3D graphic content playing device (100) according to the present invention may set up the depth information of the corresponding object by using diverse methods.

First of all, the 3D graphic content playing device (100) may set up the depth information of the corresponding object by using the calling order of the object output command. For example, the first object having its output command called upon has the smallest depth information value, and the last object having its output command called upon has the greatest depth information value. More specifically, the depth information may be set up to be gradually increased in accordance with the calling order of the output command.

Secondly, the 3D graphic content playing device (100) may set up the depth information of the corresponding object by using the location information of the object. For example, as the object is located on an uppermost portion of the 2D graphic image, the depth information may be set up to have the smallest value, and, as the object is located on a lowermost portion of the 2D graphic image, the depth information may be set to have the greatest value.

Thirdly, the 3D graphic content playing device (100) may set up the depth information of the corresponding object by using the size information of the object. For example, as the size of the object is smaller, the depth information may be set up to have the smaller value, and, as the size of the object is larger, the depth information may be set up to have the greater value.

In order to set up the depth information of the object, the 3D graphic content playing device (100) according to the present invention may individually perform the above-described methods or may perform multiple methods at the same time.

Additionally, the 3D graphic content playing device (100) determines whether more objects that are to be outputted remain, (S108) and when it is determined that more objects that are to be outputted remain, the 3D graphic content playing device (100) re-performs the depth information set up procedure of the corresponding object.

Moreover, when objects that are to be outputted no longer remain, the 3D graphic content playing device (100) may use the depth information of the objects, which are set up as described above, so as to generate the 3D graphic content. (S110)

As described above, the 3D graphic content playing device (100) may adjust the difference in the distance between a corresponding object and the left eye graphic image (301) and the distance between the corresponding object and the right eye graphic image (303), thereby being capable of adjusting the stereoscopic degree of the corresponding object.

Therefore, based upon the depth information of the object, which is set up as described above, the 3D graphic content playing device (100) generates the left eye graphic image (301) and the right eye graphic image (303). More specifically, within the graphic image of the 2D graphic content, the difference in the distance between the objects are adjusted in accordance with the depth information of each object, thereby allowing the left eye graphic image (301) and the right eye graphic image (303) to be generated.

Finally, the 3D graphic content playing device (100) outputs the generated 3D graphic content (300) to the user through a video outputting unit (190), which will be described in more detail later on. (S112)

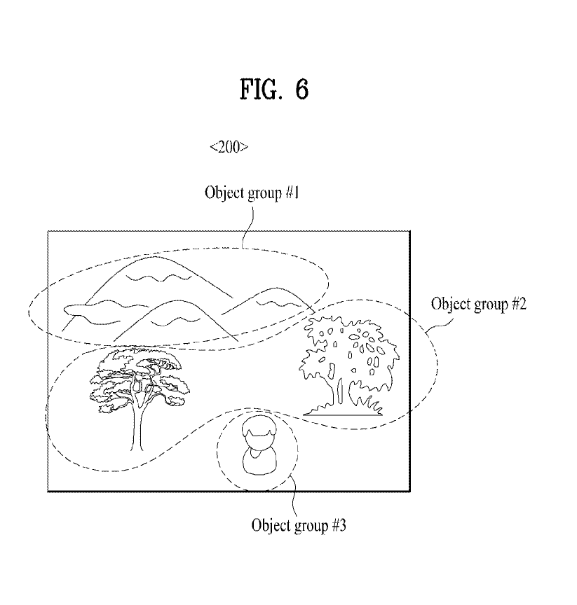

FIG. 6 illustrates a conceptual view of an object group according to the exemplary embodiment of the present invention.

In the above-described method of converting the 2D graphic content (200) to 3D graphic content (300), the depth information is set up for each object included in the 2D graphic content (200).

However, if multiple objects are included in the 2D graphic content (200), multiple sets of depth information may also be respectively set up for each object. This is advantageous in that diverse stereoscopic degrees can be provided to the user. However, due to the characteristics of 3D images, this may also cause the user to experience dizziness or confusion.

Therefore, in the present invention, Grouping is performed on the objects, and depth information is being set up for each Object Group.

As shown in the drawing, object 1 (Object #1) may be set up as object group 1 (Object Group #1), object 2 (Object #2) and object 3 (Object #3) may be set up as object group 2 (Object Group #2), and object 4 (Object #4) may be set up as object group 3 (Object Group #3).

If the depth information is set up for each object, the objects of the 2D graphic content (200) shown in the drawings may be set up to have 4 different types of depth information. More specifically, the 2D graphic content (200) is converted to the 3D graphic content (300) with 4 different types of stereoscopic degrees included therein.

However, if grouping of the objects is performed, the objects of the 2D graphic content (200) may be set up to have 3 different types of 3D effects (or stereoscopic degrees). More specifically, the 2D graphic content (200) is converted to the 3D graphic content (300) with 3 different types of stereoscopic degrees included therein.

Respectively, even in case of objects corresponding to the same object group, the depth information may be set up to have minute differences, based upon the above-described output command calling order, object location, object size, and so on.

For example, even in case of object 2 (Object #2) and object 3 (Object #3), which correspond to the same object group 2 (Object Group #2), the depth information may be differently set up for each object in accordance with the difference in the output command calling order, object location, object size of object 2 (Object #2) and object 3 (Object #3).

In the description presented above, the method of converting the 2D graphic content (200) to 3D graphic content (300) has been described in detail.

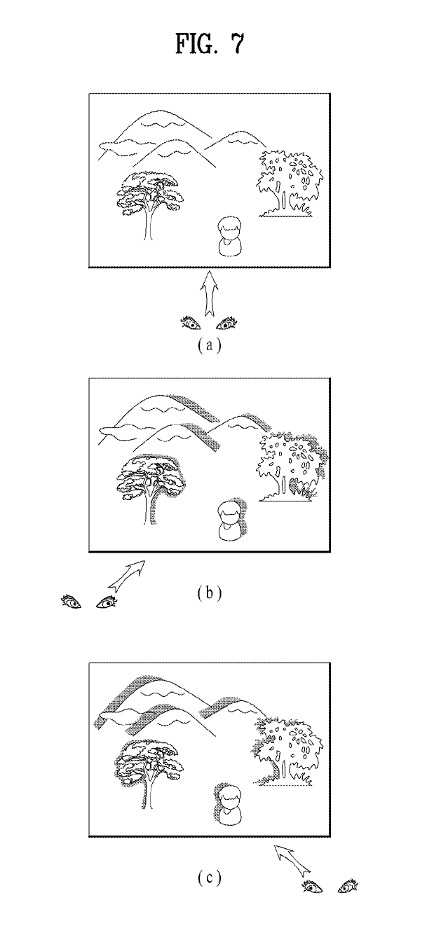

FIG. 7 illustrates a drawing for describing the output of 3D graphic content (300) with respect to a viewing direction of the user according to the exemplary embodiment of the present invention.

Fig. (a) illustrates an example of the 3D graphic content (300) being displayed on the screen, when the user is facing directly into the 3D graphic content playing device (100). In this case, each of the objects is outputted with a stereoscopic degree respective to the above-described depth information.

Fig. (b) illustrates an example of the 3D graphic content (300) being displayed on the screen, when the user is facing diagonally into the 3D graphic content playing device (100) from the left side of the device. In this case, each of the objects is outputted with a stereoscopic degree tilted leftward along with the stereoscopic degree respective to the above-described depth information.

Fig. (a) illustrates an example of the 3D graphic content (300) being displayed on the screen, when the user is facing diagonally into the 3D graphic content playing device (100) from the right side of the device. In this case, each of the objects is outputted with a stereoscopic degree tilted rightward along with the stereoscopic degree respective to the above-described depth information.

More specifically, the method for displaying 3D graphic content according to the present invention may output each object with a stereoscopic degree tilted in accordance with the viewing direction of the user.

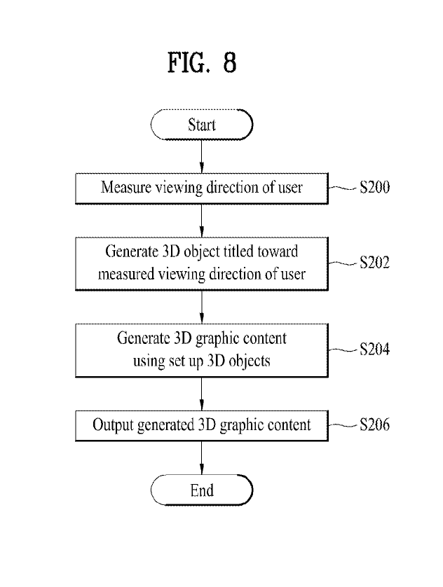

FIG. 8 illustrates a flow chart showing a method of outputting 3D graphic content with respect to a viewing direction of the user according to the exemplary embodiment of the present invention.

First of all, the 3D graphic content playing device (100) according to the present invention measures viewing direction measurements of the user. (S200) The 3D graphic content playing device (100) according to the present invention may measure the viewing direction of the user by using diverse types of sensors.

For example, the 3D graphic content playing device (100) may use a camera sensor so as to measure the user's position, direction of the user's head, and so on, thereby setting up the viewing direction of the user.

Additionally, the 3D graphic content playing device (100) may use a Gyro sensor or gravity sensor, so as to measure an tilting angle of the 3D graphic content playing device (100). The viewing direction of the user may be decided in accordance with the inclination of the 3D graphic content playing device (100). If a left side portion of the 3D graphic content playing device (100) is tilted backwards, it will be apparent that the viewing direction of the user is directed rightward.

Thereafter, the 3D graphic content playing device (100) generates a 3D object that is titled along the measured viewing direction of the user. (S202) A method of generating a 3D object in accordance with the calling order of the output command, object position, object size has already been described above, and, furthermore, a stereoscopic degree is set up, so that the generated 3D object can be tilted toward the user's viewing direction.

Additionally, the 3D graphic content playing device (100) may use the set up 3D objects, so as to generate 3D graphic content (300). (S204) Since all of the objects has the same inclination, each of the objects may be integrated, thereby generating 3D graphic content (300).

Finally, the 3D graphic content playing device (100) outputs the generated 3D graphic content (300) to the user through a video outputting unit (190).

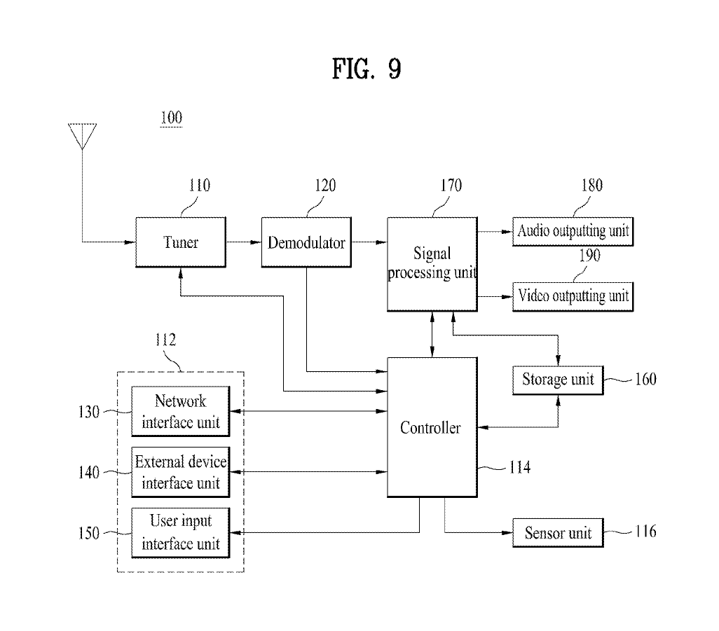

FIG. 9 illustrates a block view showing an apparatus for playing 3D graphic content (100) according to the exemplary embodiment of the present invention.

As shown in FIG. 9, the 3D graphic content playing device (100) includes a tuner (110), a demodulator (120), an interface unit (112), a controller (114), a storage unit (160), a signal processing unit (170), an audio outputting unit (180), and a video outputting unit (190).

Among diverse RF (Radio Frequency) broadcast signals being received through the antenna, the tuner (110) selects an RF broadcast signal corresponding to a channel selected by the user or an RF broadcast signal corresponding to all channels. Additionally, the selected RF broadcast signal is converted to a middle band frequency signal or a base band image or an voice signal. For example, if the selected RF broadcast signal corresponds to a digital broadcast signal, the selected RF signal is converted to a digital IF signal (DIF), and, if the selected RF broadcast signal corresponds to an analog broadcast signal, the selected RF broadcast signal is converted to an analog baseband image or an voice signal (CVBS/SIF). More specifically, the tuner (110) may process a digital broadcast signal or an analog broadcast signal. The analog baseband image or audio signal (CVBS/SIF) being outputted from the tuner (110) may be directly inputted to the signal processing unit (170).

Additionally, the tuner (110) may receive an RF broadcast signal of a single carrier respective to an ATSC (Advanced Television System Committee) mode, or the tuner (110) may receive an RF broadcast signal of a multi-carrier respective to a DVB (Digital Video Broadcasting) mode.

Meanwhile, among the RF broadcast signals being received through the antenna in the present invention, the tuner (110) sequentially receives RF broadcast signals of all broadcasting channels stored through a channel memory function, thereby being capable of respectively converting the selected RF broadcast signals to a middle band frequency signal or a baseband image or an audio signal.

The demodulator (120) receives the digital IF signal (DIF), which is converted by the tuner (110), and performs demodulation operations. For example, when the digital IF signal being outputted from the tuner (110) corresponds to an ATSC mode, the demodulator (120) performs 8-VSB (7-Vestigal Side Band) demodulation. Additionally, the demodulator (120) may also perform channel decoding. In order to do so, the demodulator (120) may be equipped with a Trellis Decoder, a De-interleaver, a Reed Solomon Decoder, and so on, thereby being capable of performing trellis-decoding, de-interleaving, and Reed Solomon decoding.

For example, in case the digital IF signal being outputted from the tuner (110) corresponds to a DVB mode, the demodulator (120) performs COFDMA (Coded Orthogonal Frequency Division Modulation) modulation. Additionally, the demodulator (120) may also perform channel decoding. In order to do so, the demodulator (120) may be equipped with a convolution decoder, a de-interleaver, a Reed-Solomon decoder, and so on, thereby being capable of performing convolution decoding, de-interleaving, and Reed-Solomon decoding.

After performing demodulation and channel decoding, the demodulator (120) may output a stream signal (TS). At this point, the stream signal may correspond to a signal having a video signal, audio signal, or data signal multiplexed therein. For example, the stream signal may correspond to an MPEG-2 TS (Transport Stream) having a video signal of an MPEG-2 standard, an audio signal of a Dolby AC-3 standard, and so on multiplexed therein. More specifically, the MPEG-2 TS may include a 4-byte header and a 184-byte payload.

The stream signal outputted from the demodulator (120) is included to the signal processing unit (170). The signal processing unit (170) performs demultiplexing, video/audio signal processing, and so on, so as to output an image to the video outputting unit (190) and to output a sound (or voice) to the audio processing unit (180).

The interface unit (112) transmits/receives data to/from a mobile terminal, which is connected to the interface unit (112), so as to be capable of performing communication, and, then, the interface unit (112) received the user's command. The interface unit (112) includes a network interface unit (130), an external device interface unit (140), and a user input interface unit (150).

The network interface unit (130) provides an interface for connecting the 3D graphic content playing device (100) to a wired/wireless network, which includes an internet network. The network interface unit (130) may be equipped with an Ethernet terminal, and so on, in order to be connected with the wired network, and the network interface (130) may also be equipped with WLAN (Wireless LAN) (Wi-Fi), Wibro (Wireless broadband), Wimax (World Interoperability for Microwave Access), HSDPA (High Speed Downlink Packet Access) communication standard terminals, and so on, in order to be connected with a wireless network.

The network interface unit (130) is configured to receive content or data, which are provided by the internet or a content provider or a network operator, through the network. More specifically, content, such as movie, commercial advertisement, game, VOD, broadcast signal, and so on, which is provided by the internet, content provider, and so on, through the network, and the related information may be received. Additionally, update information and update files of firmware being provided by the network operator may also be received. Furthermore, data may also be transmitted to the internet or content provider or network operator.

Moreover, the network interface unit (130) is configured to search for a mobile terminal (200), which is connected so as to perform communication, and is also configured to transmit/receive data to/from the connected mobile terminal, and so on.

Furthermore, the network interface unit (130) is, for example, connected to an IP (internet Protocol) TV, and the network interface unit (130) receives video, audio or data signals, which are processed in an IPTV set-top box, in order to perform two-way communication, so as to deliver the processed signals to the signal processing unit (170), thereby transporting the processed signals to the IPTV set-top box.

The external device interface unit (140) is configured to transmit or receive data to or from an external device. In order to do so, the external device interface unit (140) may include an A/V inputting/outputting unit (not shown) or a wireless communication unit (not shown). For example, the external device interface unit (140) may be connected to an external device, such as a DVD (Digital Versatile Disk), Blu ray, gaming device, camera, camcorder, computer (laptop), and so on, via wired/wireless connection. The external device interface unit (140) delivers video, audio or data signals, which are inputted from an external source through a connected external device, to the signal processing unit (170) of the 3D graphic content playing device (100). Additionally, the video, audio or data signals, which are processed by the signal processing unit (170), may be outputted to the connected external device. In order to do so, the external device interface unit (140) may include an A/V inputting/outputting unit (not shown) or a wireless communication unit (not shown).

At this point, the A/V inputting/outputting unit may include a USB terminal, a CVBS (Composite Video Banking Sync) terminal, a component terminal, an S-video terminal (analog), a DVI (Digital Visual Interface) terminal, an HDMI (High Definition Multimedia Interface) terminal, an RGB terminal, a D-SUB terminal, and so on, so that the video and audio signals of the external device can be inputted to the 3D graphic content playing device (100).

Furthermore, the external device interface unit (140) is connected to diverse set-top boxes through at least one of the above-described terminals, thereby being capable of performing input/output operations with the set-top box.

The user input interface unit (150) delivers a signal inputted by the user to the controller (114) or delivers a signal from the controller (114) to the user. For example, the user input interface unit (150) either receives a user input signal, such as power on/off, channel selection, screen setting, and so on, from a remote controlling device (not shown) in accordance with diverse communication methods, such as an RF (Radio Frequency) communication method, an infrared (IR) communication method, and so on.

Additionally, for example, the user input interface unit (150) may deliver a user input signal being inputted from a local key (not shown), such as a power key, a channel key, a volume key, a set-up key, and so on, to the controller (114).

A program for performing each of the signal processing and controlling procedures within the controller (114) and the signal processing unit (170) may be stored in the storage unit (160), and the signal processed video, audio or data signals may also be stored in the storage unit (160). Additionally, the storage unit (160) may perform a function of temporarily storing video, audio or data signals, which are being inputted to the external device interface unit (140), or the storage unit (160) may also store information of a predetermined broadcasting channel through a channel memory function, such as a channel map. Moreover, the storage unit (160) may store the above-described 2D graphic content (200) and the 3D graphic content (300).

The storage unit (160) may be configured of at least one of the storage medium types, such as a flash memory type, a hard disk type, a multimedia card micro type, a card type memory (e.g., SD or XD memory, and so on), RAM, and ROM (EEPROM, and so on). The 3D graphic content playing device (100) may play the 2D graphic content (200) or the 3D graphic content (300), which are stored in the storage unit (160), so as to provide the corresponding graphic content to the user.

Although FIG. 9 shows an exemplary embodiment, wherein the storage unit (160) and the controller (114) are separately provided, the scope of the present invention will not be limited only to this, and the storage unit (160) may also be configured to be included in the controller (114).

The signal processing unit (170) decodes the 2D graphic content (200) and the 3D graphic content (300), which are inputted through the tuner (110) or the demodulator (120) or the external device interface unit (140) or the storage unit (160), so as to generate and output a signal for video or audio output.

The audio signal that is processed by the signal processing unit (170) may be outputted to the audio outputting unit (180) as sound. Additionally, the audio signal that is processed by the signal processing unit (170) may be inputted to an external outputting device through the external device interface unit (140).

Moreover, the video signal that is processed by the signal processing unit (170) may be inputted to the video outputting unit (190), so as to be displayed as an image corresponding to the respective video signal. Additionally, the video signal that is video-processed by the signal processing unit (170) may be inputted to an external outputting device through the external device interface unit (140). Furthermore, the signal processing unit (170) may be configured to be included in the controller (114). However, the present invention will not be limited only to the above-described structure, and the detailed structure of the signal processing unit (170) will hereinafter be described in detail.

The controller (114) may control the overall operations within the 3D graphic content playing device (100). For example, the controller (114) controls the signal processing unit (170) in accordance with the user's command, which is received from the interface unit (112). The controller (114) controls the tuner (110), so that the tuner (110) can tune to (or select) an RF broadcast program corresponding to a channel selected by the user or a pre-stored channel.

Additionally, the controller (114) may control the 3D graphic content playing device (100) by using a user command inputted through the user input interface unit (150) or by using an internal program. For example, the controller (114) controls the tuner (110), so that a signal of a channel, which is selected in accordance with a predetermined channel selection command that is received through the user input interface unit (150), can be inputted. Moreover, the controller (114) controls the signal processing unit (170) so as to process the video, audio or data signal of the selected channel. The controller (114) controls the signal processing unit (170) so that the information on the channel, which is selected by the user, can be outputted along with the processed video or audio signal through the video outputting unit (190) or the audio outputting unit (180).

Moreover, the controller (114) controls the signal processing unit (170), so that a video signal or an audio signal received from an external device, e.g., a camera or camcorder, which is inputted through the external device interface unit (140), can be outputted through the video outputting unit (190) or the audio outputting unit (180) in accordance with an external device image playing command, which is received through the user input interface unit (150).

Meanwhile, the controller (114) may control the video outputting unit (190), so that the video outputting unit (190) can display the image through the signal processing unit (170). For example, the controller (114) may perform control operations, so that a broadcast image being inputted through the tuner (110), an external input image being inputted through the external device interface unit (140) or an image being inputted through the network interface unit (130) or an image stored in the storage unit (160) can be displayed.

Additionally, the controller (114) may control the above-described structures in order to perform the playing method by converting the 2D graphic content (200) of the above-described 3D graphic content playing device (100) to 3D graphic content (300).

More specifically, the controller (114) controls the signal processing unit (170), so as to decode the 2D graphic content (200) to the 3D graphic content (300). The method of converting the 2D graphic content (200) to the 3D graphic content (300) by using the output command calling order of the object, the position of the object, the size of the object has already been described above.

The audio outputting unit (180) receives an audio-processed signal, e.g., a stereo signal, a 3.1 channel signal, or a 5.1 channel signal, from the signal processing unit (170) and outputs the received signal as sound. The sound outputting unit (185) may be configured of diverse types of speakers.

The video outputting unit (190) converts the video signal, data signal, OSD signal, control signal, which are processed by the signal processing unit (170) or converts the video signal, data signal, control signal, and so on, which are received by the external device interface unit (140), thereby generating an driving signal. The video outputting unit (190) may be configured of a PDP, an LCD, an OLED, a flexible display, and so on, that can perform 3D display. Meanwhile, the video outputting unit (190) may also be configured of a touch screen, so as to be used as an inputting device in addition to being used as an outputting device.

Meanwhile, in order to measure the viewing direction of the user, a sensor unit (116) being equipped with at least one of a camera sensor, a gyro sensor, and a gravity sensor may be further equipped in the 3D graphic content playing device (100). The signal that is detected by the sensor unit (116) is delivered to the controller (116).

Meanwhile, the 3D graphic content playing device (100) shown in FIG. 9 is merely an example of the present invention, and, therefore, depending upon the specifications of the actual embodiment of the present invention, components may be integrated, added, or omitted. More specifically, whenever required, 2 or more components may be combined as a single component, or one component may be segmented to 2 or more components. Additionally, the functions being performed by each block are merely examples given to describe the exemplary embodiment of the present invention. And, therefore, the detailed operations or device will not limit the scope and spirit of the present invention.

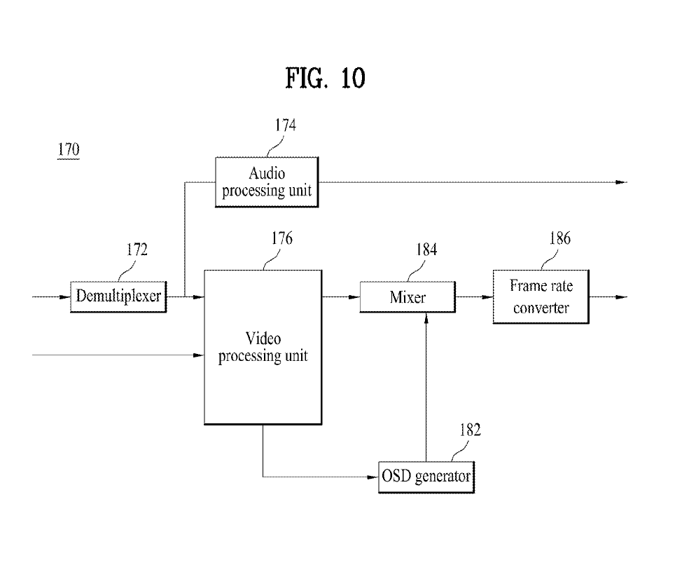

FIG. 10 illustrates a block view showing the structure of a signal processing unit shown in FIG. 9 in more detail.

As shown in FIG. 10, the signal processing unit (170) includes a demultiplexer (172), an image processing unit (176), an audio processing unit (174), an OSD generator (182), a mixer (184), and a frame rate converter (186). Furthermore, although it is not shown in the drawing, the signal processing unit (170) may further include a data processing unit.

The demultiplexer (172) demultiplexes an inputted stream. For example, when an MPEG-2 TS is being inputted, the demultiplexer (172) may demultiplex the inputted stream and may divide the demultiplexed stream into an image signal, an audio signal, and a data signal. Herein, the stream signal being inputted to the demultiplexer (172) may correspond to a stream signal being outputted from the tuner (110) or the demodulator (120) or the external device interface unit (140).

The audio processing unit (174) may perform audio processing of the demultiplexed audio signal. In order to do so, the audio processing unit (174) is further equipped with diverse types of decoders for decoding the audio signal, which is encoded by using diverse methods.

The video processing unit (176) decodes the demultiplexed video signal. The video processing unit (176) may be equipped with decoders corresponding to diverse standards. The video processing unit (176) may be equipped with at least one of an MPEG-2 decoder, an H.264 decoder, an MPEG-C decoder (MPEG-C part 3), an MVC decoder, and an FTV decoder. Additionally, the video processing unit (176) may include a 3D video decoder for decoding the 3D image signal.

The OSD generator (182) generates an OSD signal in accordance with a user input or on its own. For example, based upon an user text input signal, a signal for displaying diverse information on a display screen of the video outputting unit (190) as Graphic or Text is generated. The generated OSD signal corresponds to a user interface screen of the 3D graphic content playing device (100), which may include diverse data, such as diverse menu screens, a Favorites tray (303) screen, a widget, an icon, and so on.

The mixer (184) mixes the OSD signal, which is generated by the OSD generator (182), and the video signal, which is video-processed and decoded by the image processing unit (176). The mixed video signal is provided to the frame rate converter (186), and the Frame Rate Converter (186) converted the frame rate of the image that is being inputted.

### MODE FOR CARRYING OUT THE PRESENT INVENTION

Diverse exemplary embodiments of the present invention have been described in the best mode for carrying out the present invention.

### INDUSTRIAL APPLICABILITY

The present invention relates to a method and apparatus for playing 3D graphic content, and the present invention also relates to a method and apparatus for converting 2D graphic content to 3D graphic content and playing the converted graphic content by using the object output order.

In the description provided above, although the preferred embodiments of the present invention have been described in detail, it will be apparent that the present invention will not be limited only to this and that various modifications and variations can be made in the present invention without departing from the spirit or scope of the inventions and the scope of the detailed description of the present invention and the appended drawings of the present invention.

What is claimed is:

1. A method for playing three-dimensional graphic content, comprising:
reading two-dimensional graphic content consisting of a two-dimensional graphic image, the two-dimensional graphic image including at least one object;
receiving an output command signal of the object;
setting up depth information representing a stereoscopic degree of an object having received the output command signal; and
generating three-dimensional graphic content consisting of a left eye graphic image and a right eye graphic image using the set depth information of the object,
wherein the step of setting up depth information increases depth information value of the object based upon a received order of the output command signal of the object.

2. The method of claim 1, wherein the step of setting up depth information is performed by using position information of the object within the two-dimensional graphic image.

3. The method of claim 1, wherein the step of setting up depth information is performed by using size information of the object within the two-dimensional graphic image.

4. The method of claim 1, wherein the output command signal corresponds to an API (Application Programming Interface).

5. The method of claim 1, comprising:
grouping the objects into object groups; and
setting up depth information for each of the object groups.

6. The method of claim 1, further comprising:
measuring a viewing direction of a user; and
outputting the object at a stereoscopic degree being inclined toward the measured viewing direction of the user.

7. The method of claim 6, wherein the step of measuring a viewing direction of the user comprises:
measuring a position of the user, or measuring an inclination of an output device.

8. The method of claim 1, wherein, in the step of generating three-dimensional graphic content, based upon depth information of the object, a difference in a distance between the object of the left eye graphic image and the object of the right eye graphic image is set up.

9. An apparatus for playing three-dimensional graphic content, comprising:
An output unit configured to output three-dimensional graphic content, the three-dimensional graphic content consisting of a left eye graphic image and a right eye graphic image;
a signal processing unit configured to decode the three-dimensional graphic content; and
a controller configured to:
read two-dimensional graphic content consisting of a two-dimensional graphic image, the two-dimensional graphic image including at least one object,
receive an output command signal of the object,
set up depth information representing a stereoscopic degree of an object having received the output command signal, and
control the signal processing unit to generate the three-dimensional graphic content using the set depth information of the object,
wherein the controller increases depth information value of the object based upon a received order of the output command signal of the object.

10. The apparatus of claim 9, wherein the controller sets up depth information of the object using position information of the object within the two-dimensional graphic image.

11. The apparatus of claim 9, wherein the controller sets up depth information of the object using size information of the object within the two-dimensional graphic image.

12. The apparatus of claim 9, wherein the output command signal corresponds to an API (Application Programming Interface).

13. The apparatus of claim 9, wherein the controller groups the objects into object groups, and sets up depth information for each of the object groups.

14. The apparatus of claim 9, further comprising:
a sensor unit configured to measure a position of the user, or to measure an inclination of the output unit.

15. The apparatus of claim 14, wherein the controller controls the sensor unit to measure a viewing direction of a user, and outputs the object at a stereoscopic degree being inclined toward the measured viewing direction of the user.

16. The apparatus of claim 9, wherein, based upon depth information of the object, the controller sets up a difference in a distance between the object of the left eye graphic image and the object of the right eye graphic image, so as to generate the 3D graphic content.
